(19) United States
(12) Patent Application Publication
(10) Pub. No.: US 2025/0191498 A1
(43) Pub. Date: Jun. 12, 2025

(54) CHEST TUBE AND PERICARDIOCENTESIS TRAINER APPARATUS

(71) Applicant: HALO MED LLC, Scarborough, ME (US)

(72) Inventor: Jason F Hine, Scarborough, ME (US)

(21) Appl. No.: 19/056,552

(22) Filed: Feb. 18, 2025

Related U.S. Application Data
(63) Continuation-in-part of application No. 18/255,051, filed on May 30, 2023.
(60) Provisional application No. 63/121,808, filed on Dec. 4, 2020.

(51) Int. Cl. G09B 23/30

(52) U.S. Cl. CPC G09B 23/306

(57) ABSTRACT

A simulator apparatus for training medical professionals in the procedures of chest tube insertion and/or pericardiocentesis. The apparatus includes a first stand element and a second stand element that form a rib panel base with the two elements substantially at right angles to one another to create a 90-degree stand. A rib panel is removably joined to the two stand elements and includes curved slots representing the spaces between ribs. For simulation of the pericardiocentesis procedure, in an embodiment, a heart component located within the simulator allows the user to simulate insertion of chest tubes between the simulated rib spaces into or around the heart. The model may also use a subcutaneous and skin overlay for human skin simulation.

### BACKGROUND OF THE INVENTION

### 1. Field of the Invention

The present invention relates to the training of medical professionals in the procedures involving the chest and thoracic region. More particularly, the present invention relates to apparatuses and methods for training medical professionals to carry out chest procedures such as, but not limited to, pericardiocentesis. Still more particularly, the present invention relates to a convenient, relatively inexpensive, and portable simulator apparatus designed to simulate the conditions associated with chest tube insertion.

### 2. Description of the Prior Art

Emergency medicine and other medical specialties are responsible for performing several lifesaving procedures. Many of these procedures are rare, limiting the amount of skill maintenance that can be done with patient care. Procedural skill proficiency and competence can be maintained through simulation, but most active practicing clinicians do not have ready access to a simulation center. The training of medical professionals requires access to easy-to-use simulators which allow procedural skillset maintenance, as well as the training of medical students, residents, and other learners.

Many current trainers are complex, expensive, and are therefore only available to learners/practitioners who have access to a simulation center. Most currently practicing clinicians do not have ready access to a simulation center, have to pay significant costs for the use of a simulation center space and resources, and/or do not, given the above noted obstacles, utilize such facilities for a variety of reasons. This leads to procedural skill set decay, especially in uncommon and infrequent procedures. Having deliverable trainers to the end users' homes or places of practice, would help eliminate many of these barriers to procedural training and, therefore, procedural skill maintenance.

A need therefore exists for low- to mid-fidelity simulators that can be utilized outside of a simulation center. In particular, practitioners would benefit from easy assembled, simple to use simulators that maintain the necessary fidelity to practice procedures, particularly ones that are rarely seen in clinical practice. Such a simulator would be especially useful in two important, but rarely executed medical procedures-chest tube insertion and pericardiocentesis.

### SUMMARY OF THE INVENTION

The current invention provides a solution to the need for a simulator that aids in training users to carry out chest tube insertion, pericardiocentesis procedures, and other procedures involving the ribs, heart, and surrounding pleura. The invention is a medical procedure training simulator apparatus that facilitates the practice of procedures involving the chest and heart, such as chest tube insertion and pericardiocentesis. The simulator is in the form of an easy-to-ship product that can be utilized anywhere. Prior to this invention, the ability to practice these procedures in situ (where providers practice medicine, an ideal location for training) or in the home environment, was not feasible to the training or practicing clinician due to lack of access, expense of materials or a combination of the above.

In an embodiment, the simulator is a three-part structure: a first stand element and a second stand element that are removably attached together to form a rigid, but collapsible, 90-degree base, and a rib panel, which is removably attached to the base. The combination of two-element base and rib panel is configured so that the simulator can lay on a standard-dimension medical basin for support and ease of access, but it can also be used in other settings. The rib panel is a frame, which may be a rectangular frame, with internal curved slot elements designed to mirror the anatomy of the human rib cage, and a plurality of methods of attachment.

The attachments may be a combination of hinges, clips, latches, or other forms of removable attachment. For example, in an embodiment, the first stand element and the second stand element may be connected together with a hinge element. The hinge may be formed to allow the first stand element and second stand element to be collapsed to rest flat on a table or other structure, or opened to form a 90-degree base. The rib panel may also be attached to the first stand element with a hinge. When opened, the first stand element and second stand element form a base having about a 90-degree angle, with the rib panel resting across the first stand element and the second stand element at the hypotenuse. In this embodiment, the rib panel may have a clip or latch (located on the opposite side of the hinge feature) to attach to the second stand element.

In another embodiment, the first stand element has two or more clips protruding from an edge thereof, dependent on the specific configuration of the base to be formed, and two or more slots inset from an edge opposing the edge having the protruding clips. Alternatively, the first stand element has a multitude of hinge elements located on the edge thereof, dependent upon the specific configuration of the base to be formed, which engage with a multitude of hinge elements located on an edge of the second stand element. The edge associated with the slots may include a lip affixed thereto extending at about a 90-degree angle from that edge and arranged to enable the slot edge to be spaced above an underlying substrate when the simulator is assembled.

The second stand element may have ports spaced from an edge thereof and corresponding in number to the number of clips or other methods of attachment of the first stand element. The ports of the second stand element have dimensions about the same as but slightly larger than the dimensions of the clips or other methods of attachment of the first stand element so that the clips or other methods of attachment of the first stand element and the ports of the second stand element can be removably joined together. When that joining is completed, the base of the simulator is established as an upright frame with the second stand element extending upwardly from the edge of the first stand element with the clips at an angle of about 90 degrees. The second stand element may also have two or more slots inset from an edge opposing the edge having the ports.

The base formed by removably joining the first stand element and the second stand element together establishes an angled frame that is used to removably secure the rib panel therein. The rib panel includes a panel body having a first edge spaced from an opposing second edge. Each of the first and second edges includes two or more wings extending therefrom. The wings are configured to removably fit into the slots of the first and second stand elements, wherein the wings of the first edge of the panel fit into the slots of the first stand element and the wings of the second edge of the panel fit into the slots of the second stand element. When the rib panel is inserted into the base, the rib panel rests at an angle of about 45 degrees between the first stand element and the second stand element. The rib panel includes a panel body between the first edge and second edge. The panel body includes a set of parallel curved slots extending within a perimeter of the panel body, and corresponding parallel curved slats between slots. Curvature of the parallel curved slats is selected to represent human's ribs. The parallel curved slats may be aligned in a two- or three-dimensional manner.

The simulator of the present invention with the combination of the base and rib panel can be used to carry out chest tube insertion training. Specifically, the first and second stand elements are clipped together to create the base. The practitioner can then lay the rib panel into the base. The practitioner can then place off-the-shelf subcutaneous tissue and training skin overlays to allow for the practice of inserting chest tubes and pigtail catheters through the overlays and into the curved slots of the rib panel. At least one side of the rib panel may include attachment elements such as pegs, which attachment elements can be used to attach to overlays to panel.

In another embodiment, the simulator is a four-part structure: a first stand element and a second stand element that are removably clipped together with hinges to form a 90-degree base, a rib panel that is removably clipped to the first stand element with a hinge, and a fitted rib panel frame that is removably engaged to the rib panel. The rib panel frame is configured to mirror the shape of the rib panel with a middle cavity. The middle cavity of the rib panel frame allows the user access to the rib panel while the rib panel frame is engaged.

The hinge elements in the above embodiment function to engage the first stand element, second stand element, and rib panel together. The hinges allow for the invention to remain connected but facilitate easier transportation and storage. The hinge elements serve to hold each element in place while the simulator is in use. Additionally, the rib panel may be configured with a latch feature aligned to receive the second edge of the second stand element. The hinges allow for the invention to be expanded back into working condition and the latch of the rib panel engages with the second edge of the second stand element to secure the device in place for use.

The rib panel frame is a continuous piece shaped to mirror the outer edge of the rib panel. The rib panel frame has a middle cavity and a multitude of pins. The pins are aligned to be removably engaged with the rib panel to secure the rib panel frame to the rib panel. The middle cavity is aligned to allow access to the curved slots, mirroring the ribs of a human. It is possible to configure the curvature to enable tube insertion for other animals. The off-the-shelf subcutaneous tissue and training skin overlay is placed on the rib panel with the edges of the tissue overlapping the outer edge of the rib panel. The rib panel frame is then placed over the tissue and overlays and secured to the rib panel via the multitude of pins. The attachment of the rib panel and rib panel frame secures the tissues and overlays in place while the user uses the simulator.

The rib panel of the simulator can also separately be used to provide pericardiocentesis training and other procedures requiring access into the rib cage through the ribs and pleura. The rib panel may be sized and shaped to lay within a standard medical basin. During training of pericardiocentesis, the practitioner lays a simulation heart composed of off-the-shelf materials into the basin with water, water and fiber supplement, gelatin, or other substance to facilitate ultrasound use. The rib panel or rib panel with rib panel frame is then laid atop the medical basin. A training skin can then be laid over the rib panel and the practitioner can practice the procedure of pericardiocentesis, or drainage of fluid from around the heart.

In another embodiment, the chest model has a plurality of materials located on the rib panel to simulate that of the human ribs and chest cavity. The rib panel is configured to be substantially shaped like that of the human rib cage. The rib panel is also configured to receive and retain a plurality of layers designed to simulate that of the human body. In an embodiment, the layers include a skin layer, a fat layer, and a pleura layer. The skin layer is designed to simulate the human skin on the chest. The fat layer is designed to simulate fat and muscle around the chest and ribs of a human. The pleura layer is designed to simulate the pleura between the ribs of a human. The layers are designed to simulate the feel of and resistance to insertion of a needle through the layers of the human body to perform a pericardiocentesis procedure.

In yet another embodiment, the chest model includes a heart element. The heart element has a heart portion, a pericardium portion, and a pericardial space. The heart portion is designed to simulate that of the human heart. The pericardium portion is designed to simulate that of the human pericardium. The pericardium portion is formed as a sac that surrounds the heart portion. To simulate performing the pericardiocentesis procedure, the user may insert a needle through the layers of the rib model, through the pericardium portion and into the pericardial space, but not into the heart portion. The procedure is designed to drain fluid from the pericardial space surrounding the heart, and as such, the design of the simulator is to place the needle through the pericardium portion and into the pericardial space, but not into the heart portion.

The simulator of the present invention, including the combination of the base panels, rib panel, and heart element, the combination of the rib panel and the heart portion, the rib panel alone, or the heart portion alone, can be used in a convenient way in most any location to enable training for chest tube insertion or pericardiocentesis.

### BRIEF DESCRIPTION OF THE DRAWINGS

The foregoing features of the invention will be more readily understood by reference to the accompanying drawings, in which:

FIG. 1 is a plan view of the first stand element of the base of a first embodiment of the simulator apparatus of the present invention.

FIG. 2 is a side view of the first stand element.

FIG. 3 is a plan view of the second stand element of the base.

FIG. 4 is a side perspective view of the first stand element and second stand element joined together to form the base of the simulator apparatus.

FIG. 5 is a plan view of the rib panel of the present invention.

FIG. 6 is a side view of the rib panel.

FIG. 7A is a side view of the simulator apparatus of the present invention for the purpose of training chest tube insertion.

FIG. 7B is a front view of the simulator of FIG. 7A.

FIG. 8A is a plan view of the rib panel atop a medical basin for the purpose of training pericardiocentesis.

FIG. 8B is a side view of the rib panel of FIG. 8A.

FIG. 9A is a side view of a second embodiment of the simulator apparatus of the present invention for the purpose of training chest tube insertion with the rib panel frame version of the invention.

FIG. 9B is a front view of the simulator of FIG. 9A.

FIG. 10A is a side perspective view of the simulator of FIG. 9A with an exploded view of the rib panel frame.

FIG. 10B is a side view of the simulator apparatus of the present invention with the rib panel frame depicting hinge elements joining the first stand element and second stand element and the first stand element and the rib panel.

FIG. 10C is a side perspective view of the simulator of FIG. 9A collapsed to align the first stand element, the second stand element, the rib panel, and rib panel frame in a parallel fashion for easier transportation and storage.

FIG. 11 is a plan view of the rib panel atop a medical basin with the heart component located within the medical basin for the purpose of training pericardiocentesis.

FIG. 12 is a front perspective view of the present invention with the rib panel removed to show the heart component located within the medical basin.

FIG. 13 is a front perspective view of the heart portion, pericardium portion, cap, and ring of the heart component located within the basin of the present invention.

FIG. 14 is a front perspective view of the heart component depicting the heart portion located within the pericardium portion.

FIG. 15 is a cross section of the heart component depicting the heart portion located within the pericardium portion.

### DETAILED DESCRIPTION OF THE INVENTION

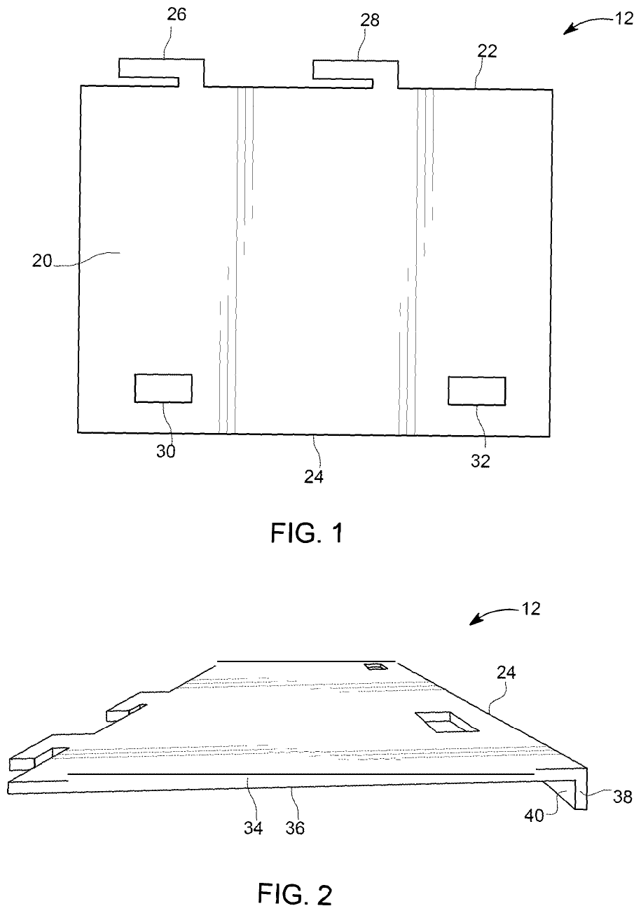

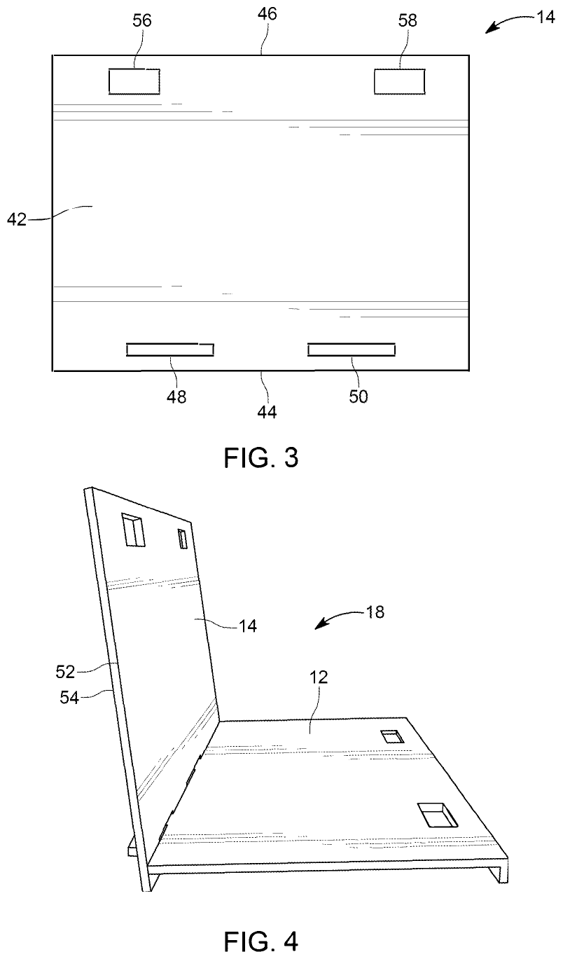

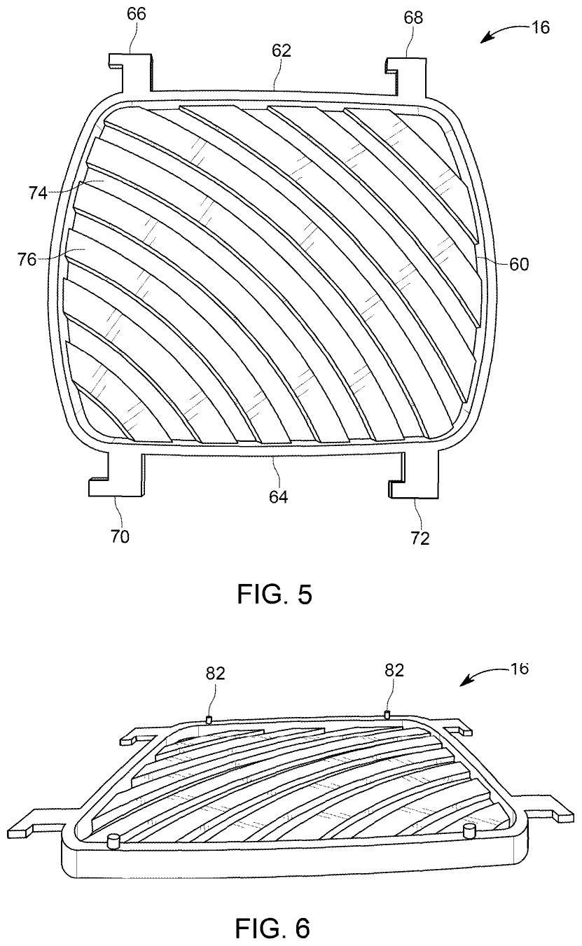

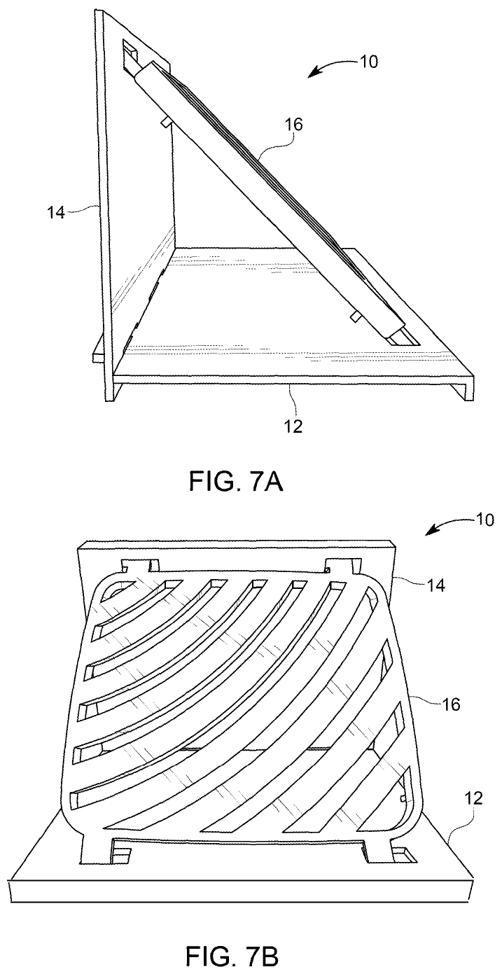

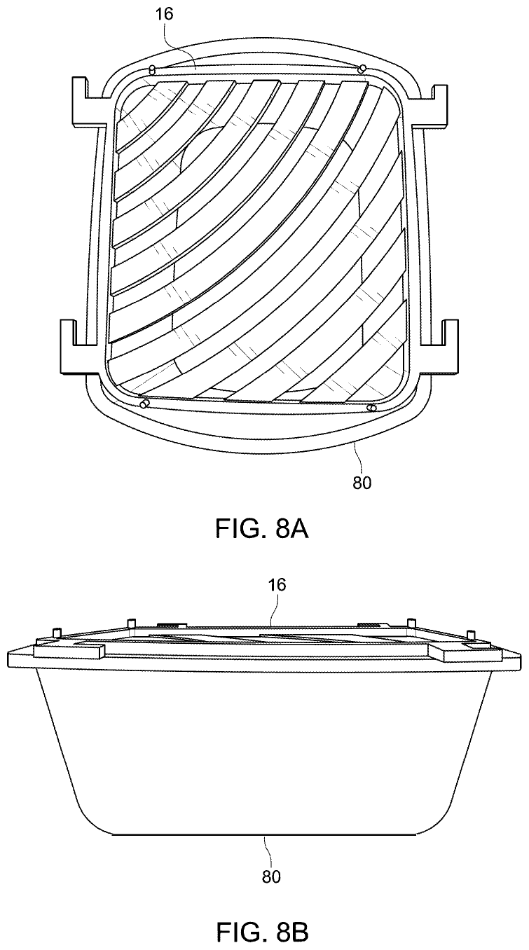

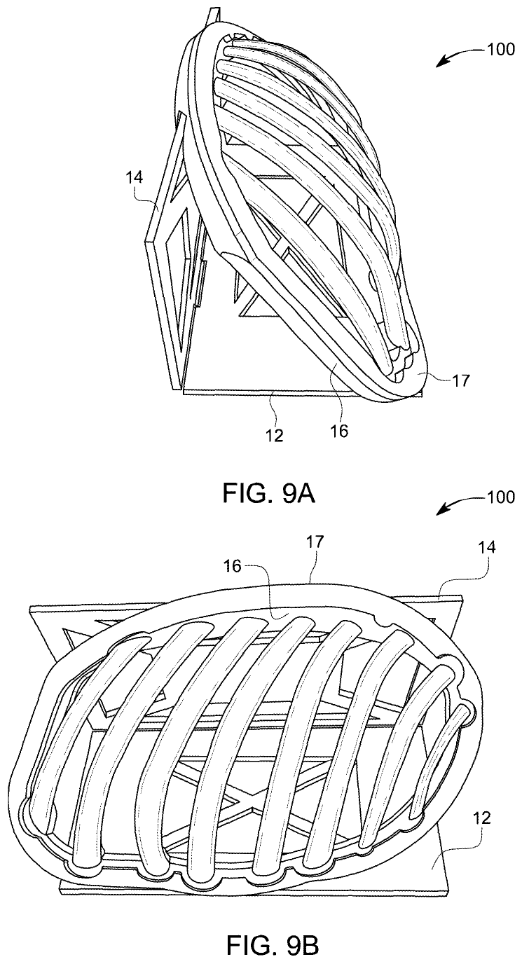

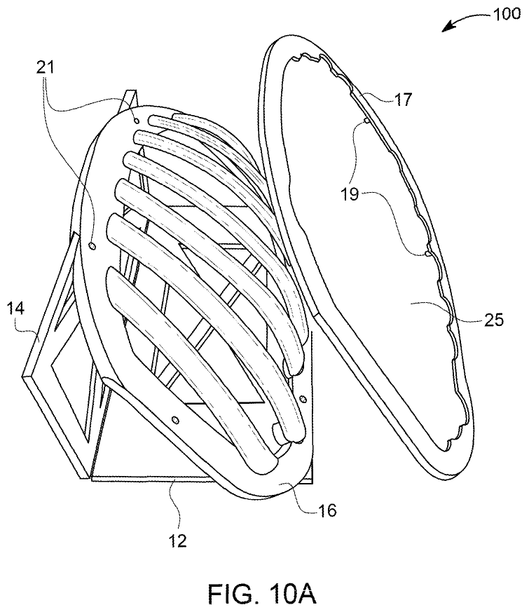

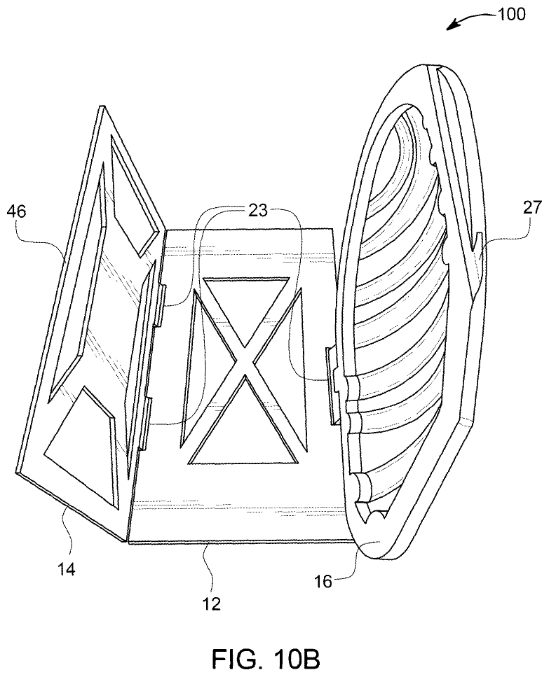

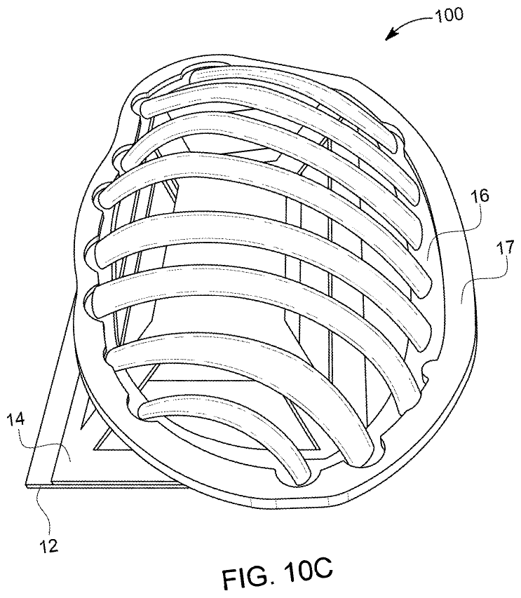

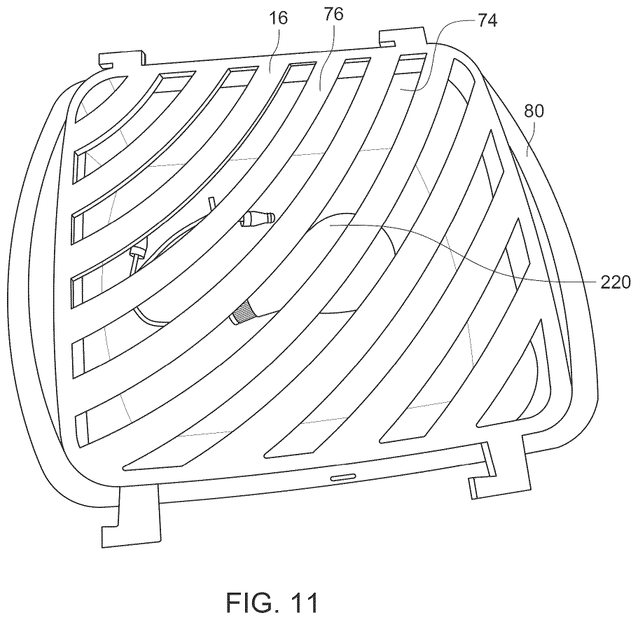

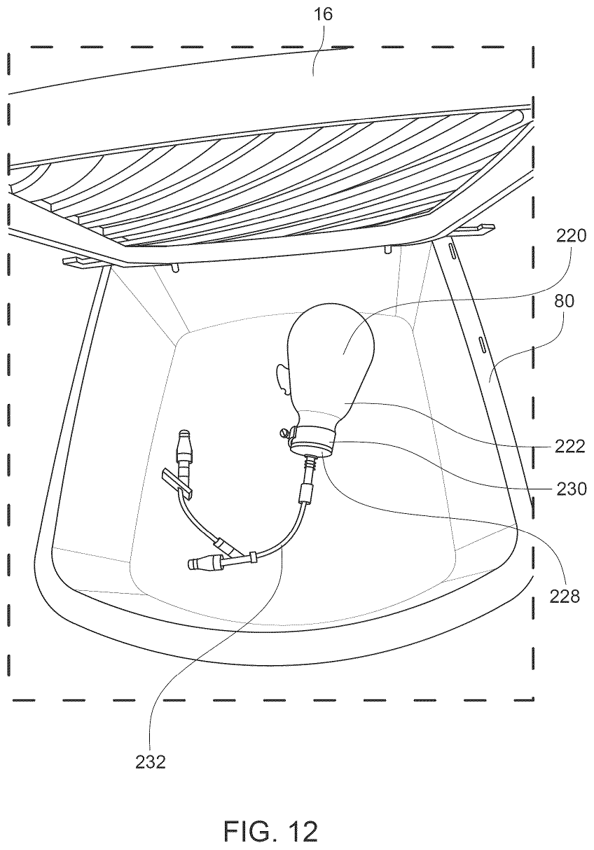

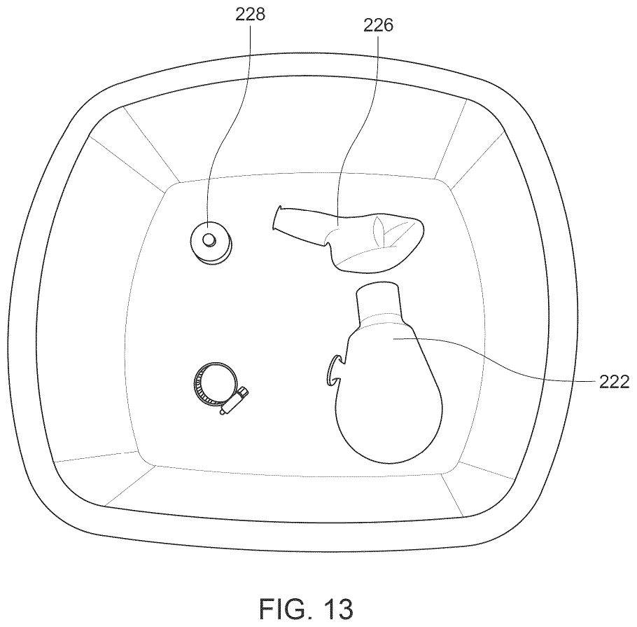

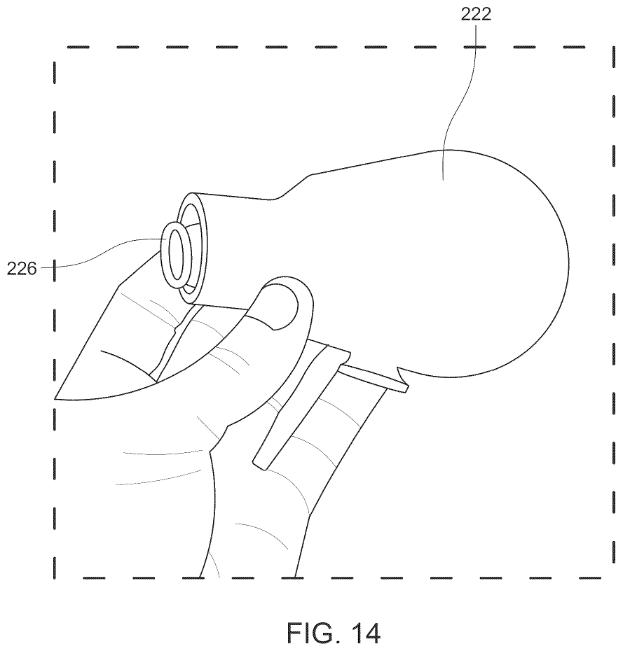

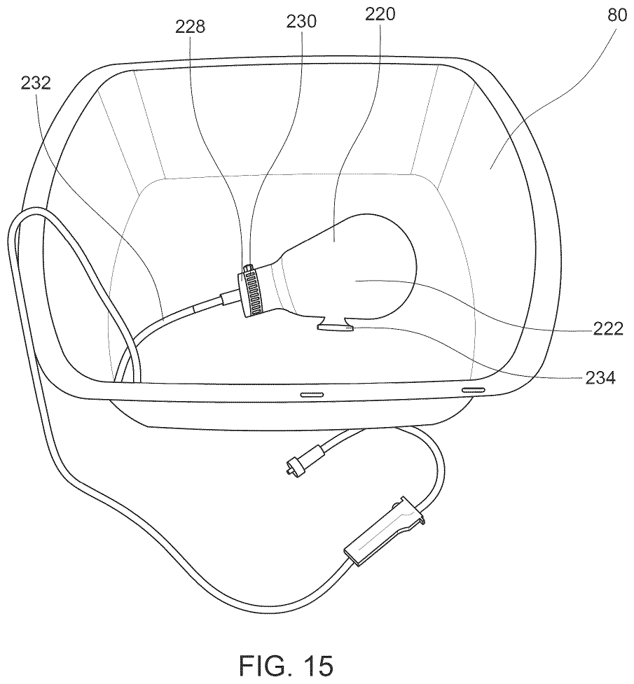

A first medical training simulator apparatus 10 is shown in FIGS. 1-8B. The simulator apparatus 10 includes a first stand element 12 shown alone in FIGS. 1 and 2, a second stand element 14 shown alone in FIG. 3, and a rib panel 16 shown alone in FIGS. 5 and 6. FIG. 4 shows the first stand element 12 and the second stand element 14 joined together to form a base 18 of the simulator apparatus 10. FIGS. 7A and 7B show the rib panel 16 coupled to the base 18. FIGS. 8A and 8B show the rib panel 16 as a standalone component suitable to aid in training for pericardiocentesis positioned on a medical basin 80. FIGS. 9A and 9B show a second medical training simulator apparatus 100 with the rib panel 16 coupled to the base 18 and a rib panel frame 17. FIG. 10A depicts the apparatus 100 of FIGS. 9A and 9B with the rib panel frame 17 detached from the rib panel 16. FIG. 10B depicts the apparatus 100 of FIGS. 9A, 9B, and 10A in an expanded view wherein a multitude of hinge elements 23 connect the first stand element 12 with the second stand element 14 and the first stand element 12 with the rib panel 16. FIG. 10C shows the apparatus 100 in a collapsed configuration for ease of transport. FIGS. 11 and 12 depict a third embodiment of the training simulator apparatus 200 with a rib panel 216 coupled to the base 18 and a rib panel frame 17 with a heart component 220. FIG. 13 depicts a cross sectional view of the heart component 220 of the simulator 200. FIGS. 14-15 depict the heart component 220 with a heart portion 226 located within a pericardium portion 222.

The first stand element 12 includes a primary body 20 with a first edge 22 and a second edge 24 opposite the first edge 22. A first clip 26 and a second clip 28 extend from the body 20 at the first edge 22. The first stand element 12 also includes a first rib panel receiving slot 30 and a second rib panel receiving slot 32 each extending partially or completely through a front side 34 to a back side 36 of the body 20 in substantial alignment with one another and set into the body 20 from the second edge 22. The first rib panel receiving slot 30 and the second rib panel receiving slot 32 are arranged to removably receive therein a portion of the rib panel 16. The number of clips may be more than two or fewer than two. The number of panel receiving slots may be more than two or less than two. The first stand element 12 may be made of any suitable material, including metallic or nonmetallic material. The nonmetallic material may be a viscoelastic material such as a polymeric material. For example, the first stand element 12 may be formed of polyethylene but not limited thereto.

The first stand element 12 optionally includes a spacing bar 38 extending from the second edge 24 on the backside 36 of the first stand element 12. The spacing bar 38 may extend partially or entirely a width of the body 20 and is of selectable height. The spacing bar 38 enables standoff of a portion 40 of the body 20 when on a substrate so that a component of the simulator 10 may be selectably and removably inserted into the slots 30 and 32.

The second stand element 14 includes a primary body 42 with a first edge 44 and a second edge 46 opposite from the first edge 44. The second stand element 14 also includes a first clip receiving port 48 and a second clip receiving port 50, each extending partially or completely through a front side 52 to a back side 54 of the body 42 in substantial alignment with one another and set into the body 42 from the first edge 44. The second stand element 14 further includes a first rib panel receiving slot 56 and a second rib panel receiving slot 58, each extending partially or completely through the front side 52 to the back side 54 in substantial alignment with one another and set into the body 42 from the second edge 46. The first clip receiving port 48 and the second clip receiving port 50 are arranged to removably retain therein the first clip 26 and the second clip 28 of the first stand element 12. The first rib panel receiving slot 56 and the second rib panel receiving slot 58 are arranged to removably receive therein a portion of the rib panel 16. The second stand element 14 may be made of any suitable material, including metallic or nonmetallic material. The nonmetallic material may be a viscoelastic material such as a polymeric material. For example, the second stand element 14 may be formed of polyethylene but not limited thereto.

FIG. 4 shows the first stand element 12 and second stand element 14 coupled together to form the base 18. Specifically, the clips 26 and 28 of the first stand element 12 are inserted into the clip receiving ports 48 and 50 of the second stand element 14 to form the base 18 having a substantially right-angle configuration with the slots 30 and 32 of the first stand element 12 angled and spaced from the slots 56 and 58 of the second stand element 14.

The rib panel 16 includes a primary body 60 with a first edge 62 and a second edge 64 opposite from the first edge 62. The rib panel 16 also includes a first rib wing 66 and a second rib wing 68 extending from the body 60 at the first edge 62, and a third rib wing 70 and a fourth rib wing 72 extending from the body 60 at the second edge 64. The rib panel is substantially symmetrical so that the first and second rib wings 66 and 68 may be removably inserted into the slots 30 and 32 of the first stand element 12 with the third and fourth rib wings 70 and 72 removably inserted into slots 56 and 58 of the second stand element 14, or the orientation of the rib wings may be reversed. FIGS. 7A and 7B show the simulator apparatus 10 put together with the first stand element 12 and second stand element 14 coupled together, as well as the rib panel 16 coupled to the first stand element 12 and the second stand element 14.

The rib panel 16 also includes a plurality of parallel curved slots 74 extending within a perimeter of the body 60, and corresponding parallel curved slats 76 alternating between the slots 74. The spacing, size and curvature of the slots 74 and slats 76 are arranged to represent a two-dimensional version of a human's ribs. Other configurations are possible provided the rib panel 16 is arranged to enable a user to simulate relevant medical activities of interest with and through the rib panel 16. For example, the rib panel 16 forming part of the simulator 10 shown in FIGS. 7A and 7B may be used to practice chest tube insertion, while the rib panel 16 alone shown in FIGS. 8A and 8B may be used to practice pericardiocentesis when removably placed on the medical basin 80.

FIGS. 9A and 9B show the second embodiment of the simulator apparatus 100 with the first stand element 12 and the second stand element 14 coupled together. The rib panel 16 is coupled to the first stand element 12 and the second stand element 14. The rib panel frame 17 is removably engaged with the rib panel 16. The rib panel 16 of the apparatus of 9A and 9B is arranged to depict the spacing, size, and curvature of the slots 74 and slats 76 to represent a three-dimensional version of a human's ribs.

FIG. 10A depicts the apparatus 100 with a multitude of pins 19 located on the rib panel frame 17 and a multitude of ports 21 located on the rib panel 16 wherein the pins 19 may be removably engaged with the ports 21 to attach the rib panel frame 17 to the rib panel 16. The pins 19 and ports 21 facilitate the coupling of the rib panel 16 to the rib panel frame 17. The rib panel frame 17 has a middle cavity 25, allowing access to the rib panel 16 by the user when the rib panel frame 17 is attached. The rib panel frame 17 secures the off-the-shelf subcutaneous tissue to the rib panel 16.

FIG. 10B depicts the apparatus 100 with the first stand element 12 and the second stand element 14 coupled together with the hinge elements 23. Additionally, the first stand element 12 and the rib panel 16 are coupled together with a hinge element 23. The apparatus 100 may have a multitude of hinge elements 23 to appropriately secure the panels together. The use of hinge elements 23 allows the user to fold the apparatus 100 into a more portable and easily transportable form. The apparatus 100 of FIG. 10B has a latch 27 which is configured to be removably engaged with the second edge 46 of the second stand element 14. The latch 27 facilitates the apparatus 100 to be secured in an “in use” position with the first stand element 12 and the second stand element 14 oriented in about a 90-degree angle, with the rib panel 16 oriented at about a 45-degree angle. The latch 27 may be uncoupled from the second edge 46 of the second stand element 14, allowing the hinge elements 23 to be utilized to fold the device down to a relatively flat orientation. The first stand element 12, the second stand element 14, and the rib panel 16 may lay flat relatively to each piece, such that the user may more easily transport the apparatus 100 while maintaining the coupling of the pieces of the apparatus 100. Alternatively, the user may utilize the apparatus 100 in its folded down manner with the rib panel 16 oriented parallel to the surface that the apparatus 100 is placed on.

FIG. 10C depicts the apparatus 100 of FIG. 9A wherein the hinge elements 23 allow the apparatus 10 to be collapsed down. The first stand element 12, the second stand element 14, the rib panel 16, and rib panel frame 17 are aligned in a parallel fashion to facilitate easier transportation and storage of the apparatus 100. The collapsed apparatus 100 of FIG. 10C is configured to be used on a flat surface or for easier transportation or storage.

The rib panel 16 optional includes one or more pegs 82 on at least one face of the body 60, which pegs may be used to removably retain to the rib panel 16 supplemental materials useful in carrying out a simulated procedure of interest. For example, practitioners can then place off-the-shelf subcutaneous tissue and skin overlay on the rib panel 16 for training in placing chest tubes and pigtail catheters, which overlays may be removably affixed to the pegs 82. The rib panel frame 17 provides another method in which to secure the off-the-shelf subcutaneous tissue and skin overlay to the rib panel 16. The rib panel 16 is designed to fit securely in the medical basin 18, with the slats 76 functioning as rib equivalents inset into the basin 80 slightly, with the opposing sets of wings 66 and 68 and 70 and 72 positioned at the most superior part of the frame of the basin 80. This allows a simulation heart, created with off-the-shelf materials, to be placed in the basin 80 which is then filled with water, water and fiber supplement, or gelatin to create an echogenic model that can utilize ultrasound for the training in ultrasound guided pericardiocentesis through the rib panel 16. The rib panel 16 may be made of any suitable material, including metallic or nonmetallic material. The nonmetallic material may be a viscoelastic material such as a polymeric material. For example, the rib panel 16 may be formed of polyethylene but not limited thereto.

FIG. 11 depicting the rib panel 16 also includes a plurality of parallel curved slots 74 extending within a perimeter of the body 60, and corresponding parallel curved slats 76 alternating between the slots 74. The heart component 220 is located beneath the rib panel 16 when in use to simulate performing procedures involving the human heart by accessing the heart component 220 between two of the slots 74 of the rib panel 16. The heart component 220 may be removably located in the medical basin 80. The rib panel 16 may be made of a plastic or other hard material designed to simulate the density of the human ribs. The heart component 220 may be made of plastic, rubber, latex, or other type of materials designed to simulate the corresponding parts of the human heart.

FIG. 12 depicts the rib panel 16 removed from the medical basin 80 to show the heart component 220 located within the basin 80. The heart component 220 has the pericardium portion 222, the heart portion 226, a cap 228, a ring 230, and an extension tubing 232. A pericardial space 224 is located between the pericardium portion 222 and the heart portion 226. The heart component 220 located within the basin 80 is designed to simulate the location of the human heart located within the human body. The heart component has a suction cup element to secure it in place in the medical basin. The rib panel 16 is designed to simulate the location of human ribs. In a typical pericardiocentesis procedure, the medical professional must access the heart through the spacing between the ribs. The present invention provides a method of simulating the pericardiocentesis procedure by providing a rib panel 16 located over the heart component 220, through which the user must access the heart component 220 through the slots 74.

FIG. 13 depicts the heart component 220 of the simulator apparatus 200. The heart component 220 is designed to simulate that of the human heart and pericardium. The heart portion 226 is designed to simulate that of the human heart. The heart portion 226 may be formed as a single compartment to simulate the muscle surrounding the atria and ventricles or may also include compartments simulating the individual atria and ventricles. The pericardium portion 222 is designed to simulate that of the human pericardium. The pericardium portion 222 is a sac-like component surrounding the heart component 220. The pericardial space 224 is designed to simulate that of the space between the heart and the pericardium of a human. The pericardial space 224 is the space between the heart portion 226 and the pericardium portion 222. The user may practice the pericardiocentesis procedure, by inserting a needle through the layers of the rib model, through the pericardium portion 222 of the heart component 220, into the pericardium space 224 of the heart component 220. The simulator 200 is designed to allow the user to practice inserting a needle into the human pericardial space, simulated by the pericardial space 224 of the present invention 200, but not into the human heart, simulated by the heart portion 226 of the present invention 200.

FIG. 14 depicts the heart portion 226 located within the pericardium portion 222 of the heart component 220. In an embodiment, the heart portion 226 is configured as a balloon or other similar structure which may be inserted into the pericardium portion 222. The pericardium portion 222 may be made of latex, rubber, soft plastic, or other such material, designed to create similar characteristics of the human pericardium. The heart portion 226, when inserted into the pericardium portion 222 may be inflated to represent the human heart surrounded by the human pericardium. The pericardial space 224 is located between the heart portion 226 and the pericardium portion 222. During the simulated procedure, the user is tasked with inserting a needle through the pericardium portion 222 into the pericardial space 224, without rupturing the heart portion 226.

FIG. 15 depicts the heart component 220 assembled, ready for use. The heart portion 226 is located within the pericardium portion 222. The tubing 232 is attached to the cap 228. The cap 228 is attached to the pericardium portion 222 and the heart portion 226. The heart component 220 is located in the basin 80. During use, the rib panel 16 is secured on top of the basin 80. The basin 80 would be filled with water, gelatin, or other such material to allow the user to use ultrasound for the procedure. The heart portion 226, once inside the pericardium portion 222, is filled with fluid to provide structure to the balloon, representing the human heart inside the human pericardium. The cap 228 is attached to the heart portion 226 and pericardium portion 222 and secured by the ring 230 to create a seal for the fluid located within the heart portion 226 and the pericardial space 224 between the heart portion 226 and the pericardium portion 222. The tubing 232 is attached to the cap 228. The tubing 232 allows for fluid to be inserted into the pericardial space 224 between the heart portion 226 and the pericardium portion 222. During the procedure, the user is tasked with inserting a needle between the slats 76 (representing the human ribs) of the rib panel 16, into the gelatin or other material filling the basin 80, through the pericardium portion 222, and into the pericardial space 224. The user will then attempt to remove the fluid from the pericardial space 224 without puncturing the heart portion 226. The heart component 220 may have an optional suction cup 234. The optional suction cup 234 removably secures the heart component to the basin 80 such that the heart component 220 does not move during use of the simulator.

The present invention has been described with reference to specific examples and configurations. It is only intended to be limited to the description set out in the claims and equivalents.

What is claimed is:

1. An apparatus for training medical professionals in a chest tube insertion procedure, the apparatus comprising:
a first stand element having a front side, a back side, a first edge, a second edge opposite the first edge, two or more clips extending from the first edge, and two or more rib panel receiving slots inset from the second edge extending partially or completely through the front side to the back side;
a second stand element having a front side, a back side, a first edge, a second edge opposite the first edge, two or more clip receiving ports inset from the first edge extending partially or completely through the front side to the back side, and two or more rib panel receiving slots inset from the second edge extending partially or completely through the front side to the back side;
a rib panel having a front side, a back side, a first edge, a second edge opposite the first edge, two or more rib wings extending from the first edge, two or more rib wings extending from the second edge, and a plurality of slots extending through the front side to the back side, wherein the plurality of slots are curved to simulate a curvature of spaces between an animal's ribs; and
a heart element having a heart portion, a pericardium portion, and a pericardial space;
wherein the two or more clips of the first stand element are removably insertable into the two or more clip receiving ports of the second stand element;
wherein the two or more rib wings of the first edge of the rib panel are arranged for removable insertion into the two or more rib panel slots of the first stand element;
wherein the two or more rib wings of the second edge of the rib panel are removably insertable into the two or more rib panel slots of the second stand element;
wherein the heart portion is surrounded by the pericardium portion; and
wherein the pericardial space is located between the pericardium portion and the heart portion.

2. The apparatus of claim 1, wherein the first stand element, the second stand element, the rib panel, the rib panel frame, and the heart element are made of a nonmetallic material.

3. The apparatus of claim 1, wherein the first stand element, the second stand element, or the rib panel has a securing feature to secure the heart portion within the apparatus.
